(19) United States
(12) Patent Application Publication
(10) Pub. No.: US 2014/0294536 A1
(43) Pub. Date: Oct. 2, 2014

(54) ANCHOR DEVICE FOR RETAINING EROSION MAT OVER PLANT GROWING LAYER IN A GREEN ROOF ASSEMBLY

(71) Applicant: Kurt Z. Horvath, Glenview, IL (US)

(72) Inventor: Kurt Z. Horvath, Glenview, IL (US)

(21) Appl. No.: 13/851,209

(22) Filed: Mar. 27, 2013

(51) Int. Cl. A01G 13/00; F16B 19/00

(52) U.S. Cl. CPC A01G 13/0225; F16B 19/00
USPC 411/500

(57) ABSTRACT

An improved anchor device for retaining an erosion mat over a plant growing medium layer in a green roof assembly. The anchor device includes a base member having an elongate rod extending from a planar portion. The base member can be placed in the green roof assembly with the rod projecting above the plant growing layer and the erosion mat. A retainer is secured to the elongate rod and holds down the erosion mat. The retainer includes plant growth openings whereby plants rooted in the plant growing layer may grow therethrough. A central opening in the retainer is defines by flexible engagement members. The rod is received through the central opening and the engagement members engage annular indentations which are formed along the rod between annular protrusions. The engagement members extend at an acute angle relative to the rod.

### BACKGROUND OF THE INVENTION

1. Field of the Invention

The present invention relates to the field of green roof assemblies which are installed on roots of buildings. More particularly, the present invention relates to an improved anchor which is used in a green roof assembly to retain the erosion mat over the plant growing medium or layer.

2. Background

Green roof assemblies are today commonly installed on roofs of buildings to beautify and improve the heating and cooling efficiency of the buildings. The green roof assembly comprises a plant growing medium layer, typically a layer of soil, placed over the building roof. The plant growing layer is covered with an erosion mat or fabric for preventing water and wind erosion of the plant growing layer. The erosion mat is made of burlap or other film materials which allow water to penetrate therethrough and descend into the plant growing layer. The erosion mat must, however, be secured and retained over the plant growing layer without penetrating or otherwise damaging the integrity of the building roof.

As shown and described in U.S. Pat. No. 7,966,779 and U.S. Pat. No. 8,127,515, the disclosures of which are incorporated herein by reference, anchorage structures have been devised for securing and retaining the erosion mat over the plant growing layer in green roof assemblies. These anchorage structures include a base member which comprise a planar portion adapted to be placed generally flat on the roof or a drainage layer on the roof. An elongate rod is secured to and extends generally perpendicular from the planar portion and, hence, generally vertically upwardly from the roof. When the plant growing layer is installed over the planar portion, the mass thereof weighs down the planar portion and thereby maintains the base member on the roof.

The length of the base member rod is greater than the depth/thickness of the plant growing layer such that the rod projects upwardly through the upper surface of the plant growing layer. The erosion mat is then installed over the plant growing layer with the rod terminal end penetrating and projecting upwardly through the erosion mat.

The anchorage structures also include a retainer having a central opening adapted to receive the base member rod therethrough. A plurality of flexible engagement members or teeth are provided in the central opening and extend radially inwardly. The engagement members are adapted to engage the rod and thereby secure the retainer along the length thereof. Accordingly, for securing the erosion mat on the plant growing layer, after placement of the erosion mat thereon with the rod terminal ends projecting through the mat, the retainers are secured to their base member by inserting the terminal upper end of the rod through the retainer central opening and sliding the retainer along the rod down and onto the erosion mat. The engagement members engage the rod and maintain the retainer in that position overlaying the erosion mat and retaining it on the plant growing layer.

Although the prior anchorage structures function quite well and attain their purpose, a better, more secure and relatively less costly anchor is needed and desired.

### SUMMARY OF THE INVENTION

The present invention is directed to an improved anchor device for securing and retaining an erosion mat over the plant growing layer of a green roof assembly whereby the erosion mat is retained more securely and whereby the plant growing area is maximized.

In one form thereof, the present invention is directed to an improved anchor device for retaining an erosion mat over a plant growing medium layer in a green roof assembly. The anchor device includes a base member and a retainer. The base member comprises a planar portion and an elongate rod secured thereto and extending therefrom. The planar portion is adapted to be weighed down by the plant growing layer with the elongate rod extending upwardly through both the plant growing layer and the erosion mat thereover. The anchor device retainer is adapted to be secured to the base member rod over the erosion mat whereby the erosion mat is retained on the plant growing layer. The improvement comprises a plant growth opening in the retainer whereby plants rooted through the erosion mat and in the plant growing layer may grow through the retainer plant growth opening.

Preferably, the retainer comprises a plurality of plant growth openings. More preferably, the retainer comprises a central portion including a central opening adapted to receive the base member rod therethrough; a perimeter portion; ribs extending between the central portion and the perimeter portion. The plant growth openings are defined between the central portion and the perimeter portion and between the ribs.

More preferably, a plurality of flexible engagement members extend radially inwardly and have terminal ends defining the central opening. The engagement members are adapted to engage the base member rod. The retainer is preferably concave shaped and, upon securement to the base member rod, the perimeter portion rests on the erosion mat and the central portion is spaced vertically above the perimeter portion.

Preferably, a plurality of annular indentations are spaced longitudinally along the base member rod and each of the annular indentations are located between a pair of annular protrusions. The flexible engagement members are adapted to extend into any one of the annular indentations between a pair of annular protrusions. More preferably, the engagement members extend at an acute angle relative to the base member rod towards the base member planar portion.

The device base member and retainer can be made of one or more of nylon, plastic or steel.

In another form thereof, the present invention is directed to an improved anchor device for retaining an erosion mat over a plant growing medium layer in a green roof assembly. The anchor device includes a base member and a retainer. The base member comprises a planar portion and an elongate rod secured thereto and extending therefrom. The planar portion is adapted to be weighed down by the plant growing layer with the elongate rod extending upwardly through both the plant growing layer and the erosion mat thereover. The anchor device retainer is adapted to be secured to the base member rod over the erosion mat whereby the erosion mat is retained on the plant growing layer. The improvement comprises a retainer having: a central portion including a central opening adapted to receive the base member rod therethrough; a perimeter portion; a plurality of flexible engagement members which extend radially inwardly and have terminal ends defining the central opening, the engagement members being adapted to engage the base member rod. The engagement members extend at an acute angle relative to the base member rod towards the base member planar portion.

Preferably, the retainer is concave shaped and, upon securement to the base member rod, the perimeter portion rests on the erosion mat and the central portion is spaced vertically above the perimeter portion. The retainer preferably includes a plurality of plant growth openings whereby plants rooted through the erosion mat and in the plant growing layer may grow through the retainer plant growth opening. A plurality of annular indentations are spaced longitudinally along the base member rod, each of the annular indentations being located between a pair of annular protrusions, and the flexible engagement members are adapted to extend into any one of the annular indentations between a pair of annular protrusions.

In yet another form thereof, the present invention is directed to improved anchor device for retaining an erosion mat over a plant growing medium layer in a green roof assembly. The anchor device includes a base member and a retainer. The base member comprises a planar portion and an elongate rod secured thereto and extending therefrom. The planar portion is adapted to be weighed down by the plant growing layer with the elongate rod extending upwardly through both the plant growing layer and the erosion mat thereover. The anchor device retainer is adapted to be secured to the base member rod over the erosion mat whereby the erosion mat is retained on the plant growing layer. The improvement comprises a retainer having: a central portion having a central opening adapted to receive the base member rod therethrough; a plurality of flexible engagement members extending radially inwardly and having terminal ends defining the central opening, the engagement members being adapted to engage the base member rod; and, a plurality of annular indentations spaced longitudinally along the base member rod, each of the annular indentations being located between a pair of annular protrusions, and wherein the flexible engagement members are adapted to extend into any one of the annular indentations between a pair of annular protrusions.

Preferably, the retainer is concave shaped and, upon securement to the base member rod, the perimeter portion rests on the erosion mat and the central portion is spaced vertically above the perimeter portion. The retainer (preferably includes a plurality of plant growth openings whereby plants rooted through the erosion mat and in the plant growing layer may grow through said retainer plant growth opening.

### BRIEF DESCRIPTION OF THE DRAWINGS

The above mentioned and other features of this invention, and the manner of attaining them, will become more apparent and the invention itself will be better understood by reference to the following description of the embodiments of the invention taken in conjunction with the accompanying drawings, wherein:

FIG. 1 is a cross sectional view of a green roof assembly showing an anchor device constructed in accordance with the principles of the present invention and holding down an erosion mat over a plant growing layer;

FIG. 2 is a is a perspective view of the base member part of the anchor device shown in FIG. 1;

FIG. 3 is a top elevation view of the retainer part of the anchor device shown in FIG. 1;

FIG. 4 is a cross sectional view of the retainer shown in FIG. 3 taken along line 4-4;

FIG. 5 is a perspective view of the retainer part of the anchor device shown in FIG. 1; and,

FIG. 6 is a partial exploded cross sectional view of the elongate rod portion of the base member part shown in FIG. 2 and the central portion of the retainer.

Corresponding reference characters indicate corresponding parts throughout several views. Although the exemplification set out herein illustrates embodiments of the invention, in several forms, the embodiments disclosed below are not intended to be exhaustive or to be construed as limiting the scope of the invention to the precise forms disclosed.

### DETAILED DESCRIPTION OF THE PREFERRED EMBODIMENTS

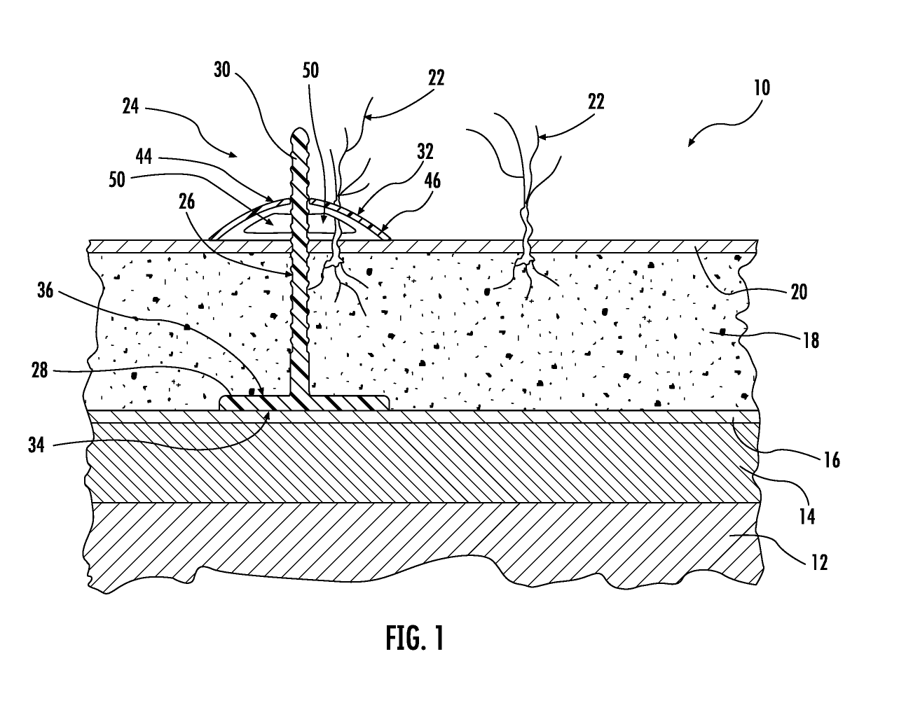

Referring initially to FIG. 1, a green roof assembly is shown in cross section and generally designated by the numeral 10. Green roof assembly 10 is installed on a roof structure or roof 12 of a budding. Roof 12 is typically generally flat or slightly inclined for causing the water to be directed to its gutters and/or drains (not shown). Green roof assembly 10 preferably includes a drainage layer or section 14 adapted to allow water to flow therethrough over the roof 12 and to the gutters and drains. A filter fabric 16 overlays the drainage layer 14 and a plant growing medium or layer 18 such a soil overlays the filter fabric 16. As can be appreciated, the filter fabric 16 prevents the soil/particles from the plant growing layer 18 from clogging the drainage layer 14. An erosion mat 20 overlays the plant growing layer 18 and prevents erosion of the plant growing layer 18 by the elements such as wind and rain and from water sprinkler systems that may be installed thereon. As used herein, erosion mat 20 means any sheet, film or mat which allows water to penetrate therethrough and descend into the plant growing layer 18 while temporarily or permanently protecting the plant growing layer 18 from the elements and includes but is not limited to biodegradable and non-biodegradable sheets, films and mats which can be made of, for example, burlap, coconut coir/fiber, straw, nylon fibers and plastic fibers. Erosion mat 20 can be provided in a pre-vegetated condition and/or is also penetrable for planting plants 22 therethrough and allowing them to root and grow. Finally, erosion mat 20 is also penetrable by the elongate rod 30 of the anchor base member 26.

The erosion mat 20 is secured and retained over the plant growing layer 18 with a plurality of anchor devices 24. The plurality of anchor devices 24 are installed in sufficiently close proximity to one another as needed for effectively holding down or retaining and preventing the elements such as the wind from uplifting the mat 20. Anchor devices 24 comprise a base member 26 which itself includes a planar portion 28 and an elongate rod 30 secured to and extending from the planar portion 28, and a retainer 32 which is adapted to be secured to the elongate rod 30 along the length thereof. Both the base member 26 and the retainer 32 are preferably made of nylon or plastic such as by injection molding, although it is contemplated that they can also be made of stainless steel or steel which has been surface treated to withstand the elements.

The base member planar portion 28 is preferably disk shaped having a downwardly facing surface 34 adapted to abut the filter fabric 16 and/or the roof 12, and having an upwardly facing surface 36. As can be appreciated, the mass of plant growing medium/layer over the upwardly facing surface 36 acts on and weighs down the planar portion 28 and, hence, holds down and maintains the base portion 26 on the roof 12. Accordingly, the area of the upwardly facing surface 36 must be sufficiently large relative to the mass and depth/thickness of the plant growing layer 18 to retain the erosion mat 20 on the plant growing layer 18 against the forces of the elements.

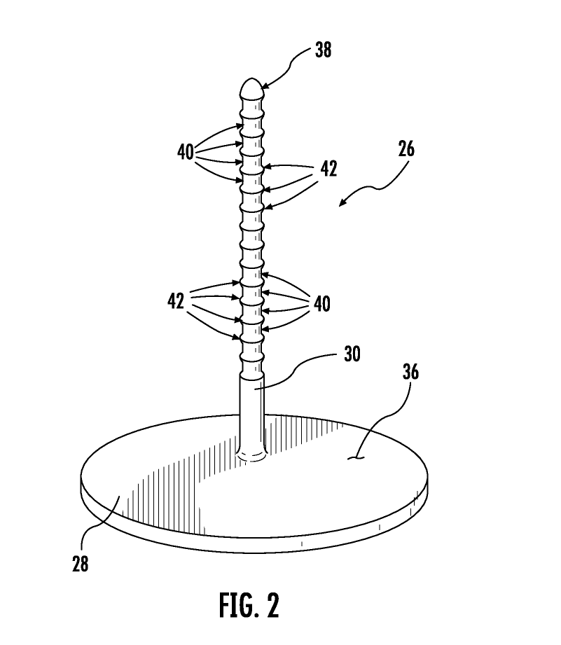

The elongate rod 30 is preferably integrally formed with the planar portion 28 such as by injection molding. Elongate rod 30 extends generally perpendicular from the planar portion 28 and, when the base member is placed on a roof 12/filter fabric 16, also extends generally perpendicular and vertically upwardly from the roof 12. Elongate rod 30 is secured generally centrally to the planar portion 28 and extends to a terminal end 38 a sufficient length such that it will project through and above the plant growing layer 18. Along its longitudinal length, as best seen in FIGS. 2 and 6, rod 30 is formed and provided with a plurality of annular indentations 40 between annular protrusions 42. That is, the annular diameter of the indentations 40 is less than the annular diameter of the protrusions 42. Also, stated differently, each of the annular indentations 40 is essentially located between a pair of annular protrusions 42.

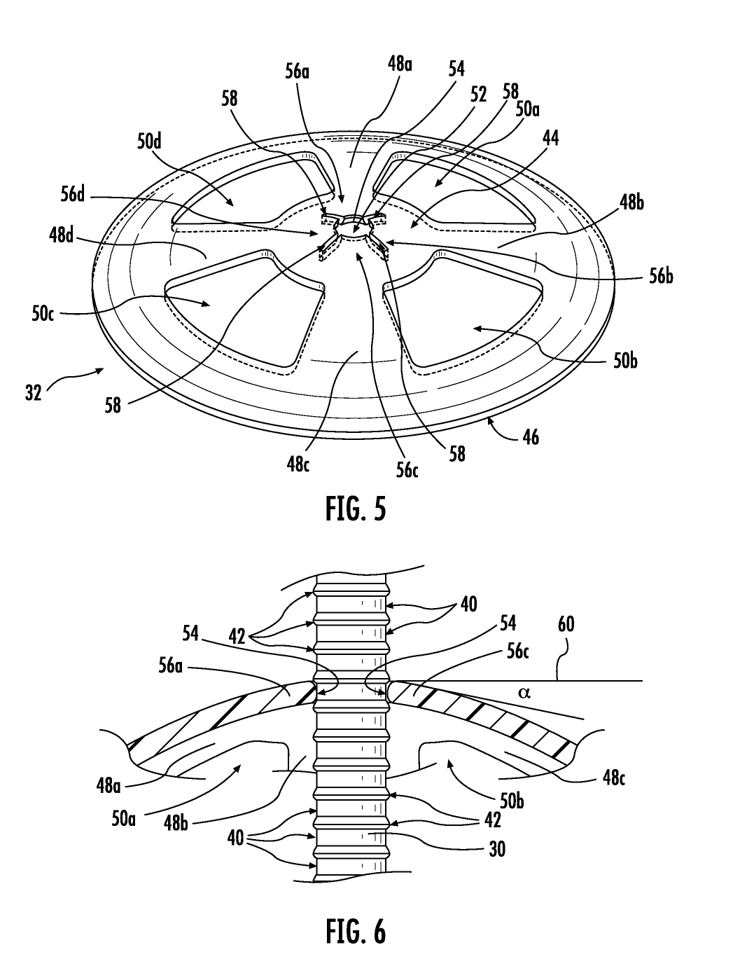

The retainer 32 is also preferably formed by injection molding and, as more particularly shown in FIGS. 3-5, includes a central portion 44 and a perimeter portion 46 joined with ribs 48a, 48b, 48c and 48d. Plant growth openings 50a, 50b, 50c and 50d are thereby formed and defined between the central portion 44 and the perimeter portion 46 and the respective ribs 48a, 48b, 48c and 48d as shown. The central portion 44 includes a central opening 52 adapted to receive the base member rod 30 therethrough as shown.

The central opening 52 is defined by the arcuate shaped terminal ends 54 of the flexible engagement members or teeth 56a, 56b, 56c and 56d which are formed in the central portion 44 between slots 58. Flexible engagement members 56a, 56b, 56c and 56d hence extend or project radially inwardly, and their arcuate terminal ends 54 form the central annular opening 52 with a diameter which is substantially the same as the diameter of the annular indentations 40 of the rod 30. By providing the slots 54 which extend radially outwardly and thereby forming the flexible engagement members 56a-d, the terminal ends 54 thereof are sufficiently flexible such that the central opening can be expanded to a diameter which is substantially the same as the diameter of the rod annular protrusions 42. That is, the engagement members 56a-d are sufficiently flexible such that the central opening 52 will expand and allow the rod annular protrusions 42 to pass therethrough.

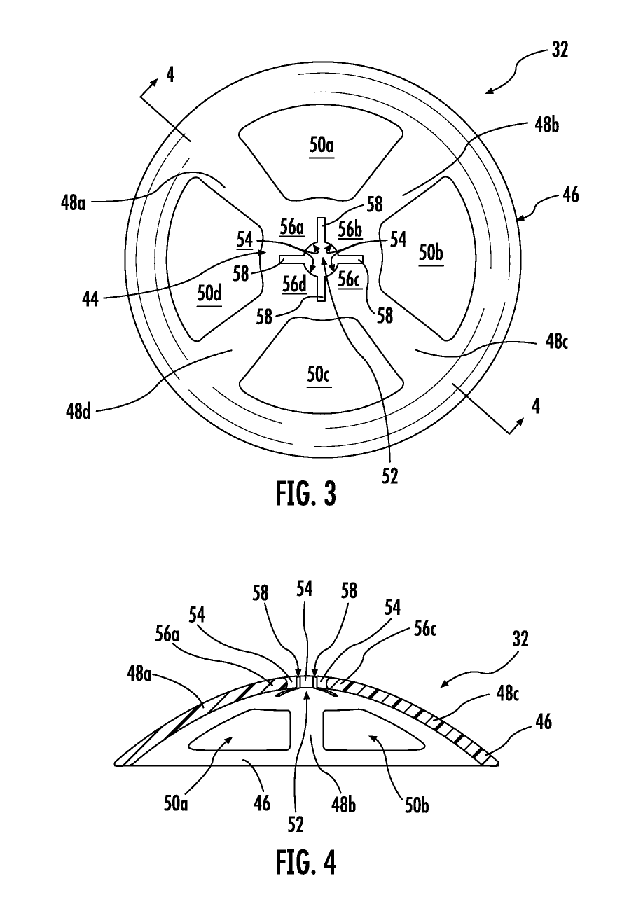

The retainer 32 is preferably concave shaped in cross section as depicted in FIG. 4. The flexible engagement members 56a-d, when the elongate rod 30 is received through the central opening 52, extend at an acute angle relative to the elongate rod 30 and toward the base member planar portion 28. As shown in FIG. 6, the flexible engagements members 56a-d extend at an angle a relative to a transverse plane 60 and, therefore, also extend at an acute angle relative to the rod toward the base member planar portion 28.

As should now be appreciated, when using the anchor device 24 in a green roof assembly 10, the base member is first installed on the roof 12/filter fabric 16 and the plant growing layer 18 is placed over the base member planar portion 28 with the elongate rod terminal end 38 projecting above the plant growing layer 18. The erosion mat 20 is then placed over the plant growing layer 18 with the elongate rod terminal end 38 penetrating and projecting through the erosion mat 20. The retainer 32 is then secured on the elongate rod 30 by inserting the rod terminal end 38 through the retainer central opening 52 and forcibly pushing the retainer 32 downwardly and onto the erosion mat 20. As the rod 30 travels through the central opening 52, the flexible engagement members 56a-d expand allowing them to slide over the annular protrusions 42. In its final securement position a shown in FIG. 1, the retainer perimeter portion 46 rests on the erosion mat 20 and the central portion 44 is spaced vertically thereabove with the arcuate terminal ends 54 of each flexible engagement member 56a-d extending into an annular indentation 40.

Advantageously, because the flexible engagement members 56a-d are at an acute angle relative to the elongate rod 30, any upward force experienced by the erosion mat 20 and transferred to the retainer 32 will force the arcuate terminal ends 54 of the engagement members 56a-d toward the annular protrusion 42 immediately thereabove and, thereby, also radially inwardly into the annular indentation 40, thereby more effectively preventing the inadvertent disengagement of the retainer 32 from the rod 30.

Also advantageously, because the retainer 32 includes plant growth openings 50a-d, plants 22 can be planted and grow therethrough as shown in FIG. 1. In this manner the retainers 32 are effectively hidden from view and “bald spots” previously caused by retainers are prevented.

While this invention has been described as having an exemplary design, the present invention may be further modified within the spirit and scope of this disclosure. This application is therefore intended to cover any variations, uses, or adaptations of the invention using its general principles.

What is claimed is:

1. An improved anchor device for retaining an erosion mat over a plant growing medium layer in a green roof assembly, said anchor device including a base member and a retainer, said base member comprising a planar portion and an elongate rod secured thereto and extending therefrom, said planar portion adapted to be weighed down by the plant growing layer with said elongate rod extending upwardly through both the plant growing layer and the erosion mat thereover, said anchor device retainer adapted to be secured to said base member rod over the erosion mat whereby the erosion mat is retained on the plant growing layer, wherein the improvement comprises:
a plant growth opening in said retainer whereby plants rooted through the erosion mat and in the plant growing layer may grow through said retainer plant growth opening.

2. The improved anchor device of claim 1 wherein said retainer comprises a plurality of plant growth openings.

3. The improved anchor device of claim 2 wherein said retainer comprises:
a central portion including a central opening adapted to receive said base member rod therethrough;
a perimeter portion;
ribs extending between said central portion and said perimeter portion; and,
wherein said plant growth openings are defined between said central portion and said perimeter portion and between said ribs.

4. The improved anchor device of claim 3 further comprising a plurality of flexible engagement members extending radially inwardly and having terminal ends defining said central opening, said engagement members adapted to engage said base member rod.

5. The improved anchor device of claim 4 wherein said retainer is concave shaped and, upon securement to said base member rod, said perimeter portion rests on the erosion mat and said central portion is spaced vertically above said perimeter portion.

6. The improved anchor device of claim 5 further comprising a plurality of annular indentations spaced longitudinally along said base member rod, each of said annular indentations being located between a pair of annular protrusions, said flexible engagement members adapted to extend into any one of said annular indentations between a pair of annular protrusions.

7. The improved anchor device of claim 6 wherein said device base member and retainer are made of one or more of nylon, plastic or steel.

8. The improved anchor device of claim 4 wherein said engagement members extend at an acute angle relative to said base member rod towards said base member planar portion.

9. The improved anchor device of claim 8 further comprising a plurality of annular indentations spaced longitudinally along said base member rod, each of said annular indentations being located between a pair of annular protrusions, said flexible engagement members adapted to extend into any one of said annular indentations between a pair of annular protrusions.

10. The improved anchor device of claim 1 wherein said retainer is concave shaped and, upon securement to said base member rod, said perimeter portion rests on the erosion mat and said central portion is spaced vertically above said perimeter portion.

11. The improved anchor device of claim 1 wherein said device base member and retainer are made of one or more of nylon, plastic or steel.

12. An improved anchor device for retaining an erosion mat over a plant growing medium layer in a green roof assembly, said anchor device including a base member and a retainer, said base member comprising a planar portion and an elongate rod secured thereto and extending therefrom, said planar portion adapted to be weighed down by the plant growing layer with said elongate rod extending upwardly through both the plant growing layer and the erosion mat thereover, said anchor device retainer adapted to be secured to said base member rod over the erosion mat whereby the erosion mat is retained on the plant growing layer, wherein the improvement comprises a retainer comprising:
a central portion including a central opening adapted to receive said base member rod therethrough;
a perimeter portion;
a plurality of flexible engagement members extending radially inwardly and having terminal ends defining said central opening, said engagement members adapted to engage said base member rod; and,
wherein said engagement members extend at an acute angle relative to said base member rod towards said base member planar portion.

13. The improved anchor device of claim 12 wherein said retainer is concave shaped and, upon securement to said base member rod, said perimeter portion rests on the erosion mat and said central portion is spaced vertically above said perimeter portion.

14. The improved anchor device of claim 12 wherein said retainer includes a plurality of plant growth openings whereby plants rooted through the erosion mat and in the plant growing layer may grow through said retainer plant growth opening.

15. The improved anchor device of claim 12 further comprising a plurality of annular indentations spaced longitudinally along said base member rod, each of said annular indentations being located between a pair of annular protrusions, said flexible engagement members adapted to extend into any one of said annular indentations between a pair of annular protrusions.

16. The improved anchor device of claim 1 wherein said device base member and retainer are made of one or more of nylon, plastic or steel.

17. An improved anchor device for retaining an erosion mat over a plant growing medium layer in a green roof assembly, said anchor device including a base member and a retainer, said base member comprising a planar portion and an elongate rod secured thereto and extending therefrom, said planar portion adapted to be weighed down by the plant growing layer with said elongate rod extending upwardly through both the plant growing layer and the erosion mat thereover, said anchor device retainer adapted to be secured to said base member rod over the erosion mat whereby the erosion mat is retained on the plant growing layer, wherein the improvement comprises:
said retainer comprising a central portion having a central opening adapted to receive said base member rod therethrough;
a plurality of flexible engagement members extending radially inwardly and having terminal ends defining said central opening, said engagement members adapted to engage said base member rod; and,
a plurality of annular indentations spaced longitudinally along said base member rod, each of said annular indentations being located between a pair of annular protrusions, said flexible engagement members adapted to extend into any one of said annular indentations between a pair of annular protrusions.

18. The improved anchor device of claim 17 wherein said retainer is concave shaped and, upon securement to said base member rod, said perimeter portion rests on the erosion mat and said central portion is spaced vertically above said perimeter portion.

19. The improved anchor device of claim 17 wherein said retainer includes a plurality of plant growth openings whereby plants rooted through the erosion mat and in the plant growing layer may grow through said retainer plant growth opening.

20. The improved anchor device of claim 17 wherein said device base member and retainer are made of one or more of nylon, plastic or steel.
